(19) United States
(12) Patent Application Publication
(10) Pub. No.: US 2017/0176934 A1
(43) Pub. Date: Jun. 22, 2017

(54) IMAGE PLAYING METHOD AND ELECTRONIC DEVICE FOR VIRTUAL REALITY DEVICE

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Minglei Chu, Tianjin (CN)

(21) Appl. No.: 15/237,671

(22) Filed: Aug. 16, 2016

Related U.S. Application Data
(63) Continuation of application No. PCT/CN2016/088677, filed on Jul. 5, 2016.

(30) Foreign Application Priority Data
Dec. 21, 2015 (CN) 201510966519.X

(51) Int. Cl. G03H 1/26; G06T 7/00; G06T 19/20; G03H 1/08; G06F 3/16; G03H 1/00; G03H 1/22; H04N 13/04; G06T 19/00

(52) U.S. Cl. CPC G03H 1/268; H04N 13/0429; H04N 13/0468; G06T 7/004; G06T 19/20; G06T 19/006; G06F 3/167; G03H 1/0005; G03H 1/2202; G03H 1/08; G03H 2001/0088; G03H 2001/2242

(57) ABSTRACT

Disclosed are an image playing method and electronic device for a virtual reality device. The image playing method includes: acquiring a holographic image in the virtual reality device, where the holographic image includes a first image and a second image; setting a first view-finding area on the first image, and setting a second view-finding area on the second image; in response to a trigger instruction of a user, adjusting a position of the first view-finding area within a range of the first image according to the trigger instruction, and at the same time adjusting a position of the second view-finding area within a range of the second image according to the trigger instruction; and sending an image corresponding to the adjusted first view-finding area to a first screen for playing, and sending an image corresponding to the adjusted second view-finding area to a second screen for playing.

### CROSS REFERENCE TO RELATED APPLICATIONS

This application is a continuation of International Application No. PCT/CN2016/088677 filed on Jul. 5, 2016, which claims priority to Chinese Patent Application No. 201510966519.X, filed before Chinese Intellectual Property Office on Dec. 21, 2015 and entitled “IMAGE PLAYING METHOD AND ELECTRONIC DEVICE FOR VIRTUAL REALITY DEVICE”, the entire contents of which are incorporated herein by reference.

### TECHNICAL FIELD

The present disclosure relates to virtual reality technologies, and more particularly, to an omnidirectional, three-dimensional image playing method and electronic device for a virtual reality device.

### BACKGROUND

With the development of virtual reality technologies, an increasing number of people watch three-dimensional images by using a related virtual reality apparatus such as a virtual reality helmet to obtain immersive visual experience. The virtual reality helmet is a helmet that blocks visual and auditory input from outside for a person by using a helmet display and guides a user to feel immersing in a virtual environment. A working principle of the virtual helmet is that inside the helmet, a left-eye screen and a right-eye screen display respectively a left-eye picture and a right-eye picture that have difference viewing angles. After human eyes acquire such picture information having different viewing angles, a three-dimensional feeling is produced in the brain.

During the implementation of the present disclosure, the inventors have found that a conventional virtual reality apparatuscan only present a partial side surface or a local portion of an object and cannot perform omnidirectional, three-dimensional presentation.

Therefore, it is very necessary to design a new, omnidirectional, three-dimensional image playing method for a virtual reality device, so as to overcome the foregoing defects, thereby implementing omnidirectional, three-dimensional playing of an image.

### SUMMARY

In view of this, the present disclosure provides an image playing method for a virtual reality device, so as to overcome defects in related art, thereby implementing holographic playing, and improving visual experience of a user.

For an image playing method for a virtual reality device according to an embodiment of the present disclosure, the virtual reality device plays an image to the left eye of a user by using a first screen, and the virtual reality device plays an image to the right eye of the user by using a second screen. The image playing method includes the following steps:

an image acquisition step: acquiring a holographic image in the virtual reality device, where the holographic image includes a first image and a second image;

a view-finding-area initialization step: setting a first view-finding area on the first image, and setting a second view-finding area on the second image;

a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and

an image playing step: sending an image corresponding to the adjusted first view-finding area to the first screen for playing, and sending an image corresponding to the adjusted second view-finding area to the second screen for playing.

For a nonvolatile computer storage media having computer executable instructions stored thereon, which is applied to a virtual reality device, according to an embodiment of the present disclosure, the virtual reality device plays an image to the left eye of a user by using a first screen, the virtual reality device plays an image to the right eye of the user by using a second screen, and the computer executable instructions are configured to:

an image acquisition step: acquiring a holographic image in the virtual reality device, where the holographic image includes a first image and a second image;

a view-finding-area initialization step: setting a first view-finding area on the first image, and setting a second view-finding area on the second image;

a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and

an image playing step: sending an image corresponding to the adjusted first view-finding area to the first screen for playing, and sending an image corresponding to the adjusted second view-finding area to the second screen for playing.

For an image playing electronic device for a virtual reality device according to an embodiment of the present disclosure, the virtual reality device plays an image to the left eye of a user by using a first screen, and the virtual reality device plays an image to the right eye of the user by using a second screen. The image playing electronic device includes:

one or more processors; and

a memory;

the memory is stored with instructions executable by the one or more processors, the instructions are configured to execute:

an image acquisition step: acquiring a holographic image in the virtual reality device, where the holographic image includes a first image and a second image;

a view-finding-area initialization step: setting a first view-finding area on the first image, and setting a second view-finding area on the second image;

a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and

an image playing step: sending an image corresponding to the adjusted first view-finding area to the first screen for playing, and sending an image corresponding to the adjusted second view-finding area to the second screen for playing.

By means of the image playing method and electronic device for a virtual reality device according to an embodiment of the present disclosure, by means of steps such as image acquisition, view-finding-area initialization, view-finding-area adjustment, and image playing, 360-degree, three-dimensional playing of a video or a picture is implemented. Meanwhile, for the image playing method and electronic device for a virtual reality device according to the present disclosure, relatively desirable initial parallax can be further set automatically, and playing parallax can also be adjusted in real time according to a related instruction, to enable a user to obtain excellent visual experience.

### BRIEF DESCRIPTION OF THE DRAWINGS

For a better understanding of the embodiments of the disclosure or the technical scheme of the existing technology, a brief introduction is given below to the drawings needed in the description of the embodiments or existing technology. Obviously, the following drawings are some embodiments of the disclosure simply; for those skilled in the art, other drawings can be obtained according to these drawings without creative work.

FIG. 1 illustrates a preferred embodiment of an image playing method for a virtual reality device according to the present disclosure.

FIG. 2 is a status diagram illustrating view-finding-area initialization in a preferred embodiment of the present disclosure.

FIG. 3 is a schematic diagram illustrating a first setting process of a view-finding area in a preferred embodiment of the present disclosure.

FIG. 4 is a schematic diagram illustrating a second setting process of a view-finding area in a preferred embodiment of the present disclosure.

FIG. 5 is a schematic diagram illustrating coordinate changes of the head of a user in a preferred embodiment of the present disclosure.

FIG. 6 illustrates a preferred embodiment of an image playing apparatus for a virtual reality device according to the present disclosure.

FIG. 7 is a schematic diagram of a structure of a hardware of the electronic device of the image playing method for a virtual reality device according to the present disclosure.

### DETAILED DESCRIPTION

The present disclosure is described below in detail with reference to the embodiments. It should be noted that the terms “front”, “rear”, “left”, “right”, “on”, and “under” used in the following description refer to directions in the accompanying drawings.

The present disclosure provides an image playing method and electronic device for a virtual reality device. The virtual reality device may store a holographic image, the virtual reality device plays an image to the left eye of a user by using a first screen, and the virtual reality device plays an image to the right eye of the user by using a second screen. Preferably, the holographic image may be divided into a first image and a second image. An image that is played on the first screen to the left eye of the user is taken from the first image, and an image that is played on the second screen to the right eye of the user is taken from the second image.

For the image playing method and electronic device for a virtual reality device according to the present disclosure, the virtual reality device may be understood as various devices that can provide the user with three-dimensional visual experience, and is, for example, a virtual helmet, and smart glasses.

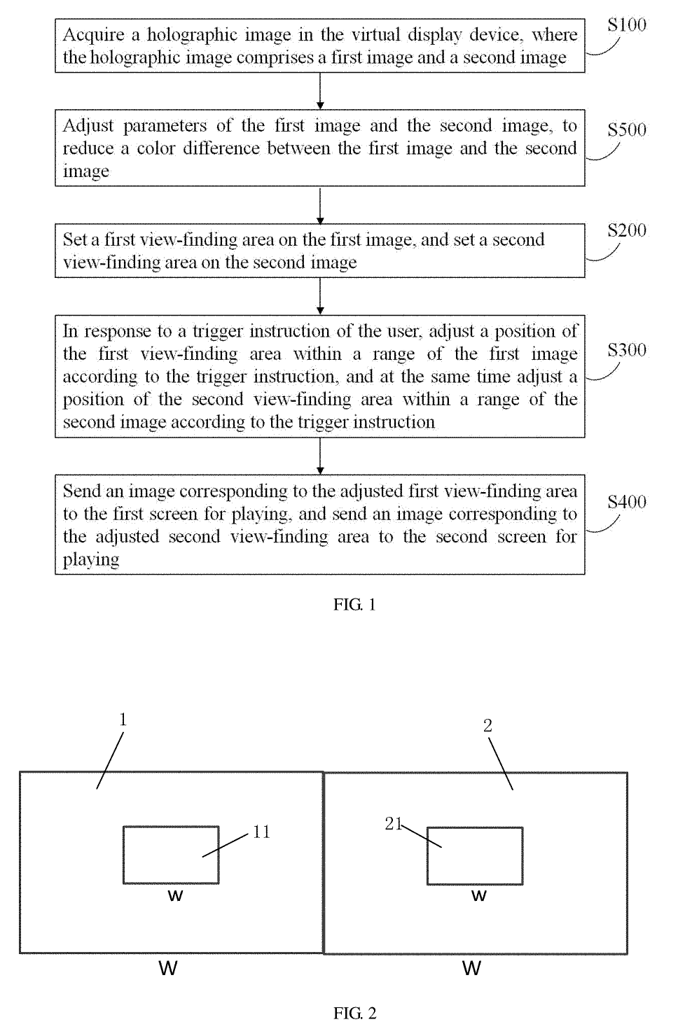

FIG. 1 illustrates a preferred embodiment illustrating an image playing method for a virtual reality device according to the present disclosure. As illustrated in FIG. 1, the image playing method for a virtual reality device according to the present disclosure may be implemented by using the following steps.

Step S100: an image acquisition step.

In the image acquisition step, a holographic image in the virtual reality device is acquired, where the holographic image includes a first image and a second image. The holographic image may be prestored in a memory of the virtual reality device. In a preferred embodiment, the holographic image may be various three-dimensional holographic images that are photographed by using a 360-degree omnidirectional photographing apparatus, or may be various three-dimensional images that are obtained through post production and synthesis. For example, the holographic image may be implemented by using 360-degree left and right pictures or 360-degree left and right synthesized videos.

To enable a user to experience a three-dimensional effect, the holographic image may usually be used to perform omnidirectional presentation of an object, and generally the holographic image is divided into a first image and a second image. In a preferred embodiment, an image watched by the left eye of the user is mainly taken from the first image, and an image watched by the right eye of the user is mainly taken from the second image.

Step S200: a view-finding-area initialization step.

In the view-finding-area initialization step, a first view-finding area is set on the first image, and a second view-finding area is set on the second image. A major objective of the view-finding-area initialization step is to determine, on the first image, an image range to be presented to the left eye of the user, and determine, on the second image, an image range to be presented to the right eye of the user, and set one initial position for the foregoing two ranges. In subsequent various processing steps, the initial position determined in the step may be used as a reference to perform adjustment.

Preferably, the first view-finding area may be set in a central position of the first image, and the second view-finding area may also be set in a central position of the second image. Such a design can effectively ensure that two view-finding areas have relatively large adjustable ranges on an image. In addition, initial positions of the first view-finding area and the second view-finding area may be further changed correspondingly according to a specific requirement.

In a preferred embodiment, the view-finding-area initialization step may be implemented by using the following manner: First, a parallax percentage range value between the first image and the second image is calculated; second, a parallax percentage range threshold is set, where the parallax percentage range threshold is parallax percentage range tolerable to the user when the watches an image; and third, the first view-finding area is set on the first image according to the parallax percentage range value and the parallax percentage range threshold, and at the same time the second view-finding area is set on the second image according to the parallax percentage range value and the parallax percentage range threshold.

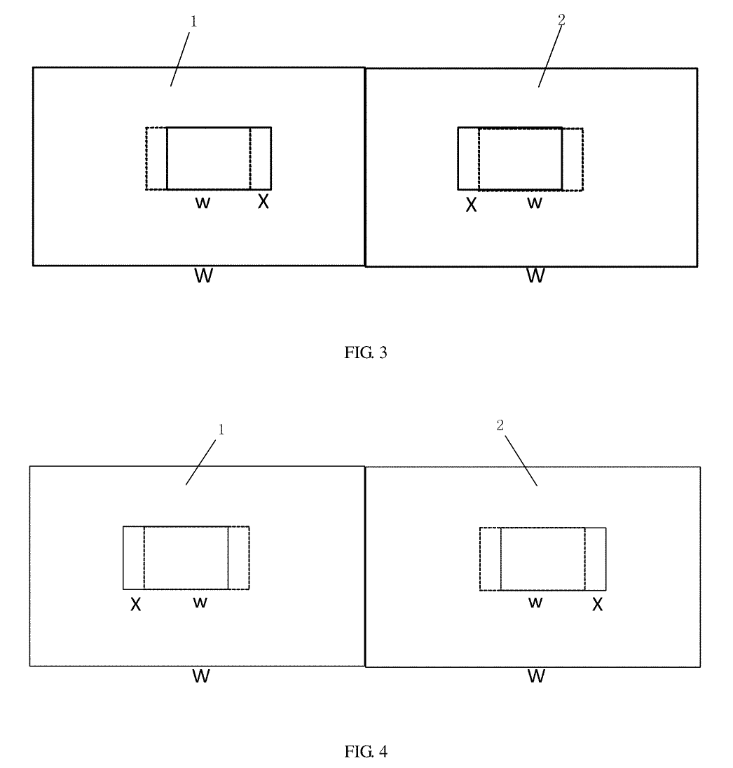

Specifically, FIG. 2 is a status diagram illustrating view-finding-area initialization in a preferred embodiment of the present disclosure; FIG. 3 is a schematic diagram illustrating a first setting process of a view-finding area in a preferred embodiment of the present disclosure; and FIG. 4 is a schematic diagram illustrating a second setting process of a view-finding area in a preferred embodiment of the present disclosure. As illustrated in FIG. 2, a first view-finding area 11 is set on a first image 1, and at the same time a second view-finding area 21 is set on a second image 2.

Referring to FIG. 2, FIG. 3, and FIG. 4, in a preferred embodiment, the view-finding-area initialization step may be implemented by using the following process.

Calculation of a parallax percentage is performed on a holographic image (which may include a holographic picture or video). Specifically, for calculation of a parallax percentage, various manners may be used for calculation. For example, for a holographic three-dimensional picture, objects having maximum parallax and minimum parallax may be chosen from the three-dimensional picture. A position PL of the object in a left image and a position PR of the object in a right image are manually measured, so that parallax of the object is PL.x-PR.x (where PL.x denotes a component of PL in the direction x, and PR.x denotes a component of PR in the direction x). A picture matching method may also be used to match each pixel on the left image and the right image, so as to calculate parallax of the three-dimensional picture. For a video, some video frames including maximum parallax and minimum parallax may be chosen from the video, and processing is performed by using the foregoing manner of picture processing, so as to obtain approximate parallax of video. It may be understood that, for calculation of parallax, the present disclosure is not limited to the foregoing method, and calculation may be further performed by using other methods, which are no longer enumerated herein. Next, maximum parallax P_{MAX1} and minimum parallax P_{MIN1} of a holographic picture or video are recorded according to a calculation result, and a maximum parallax percentage PR_{MAX1} and a minimum parallax percentage PR_{MIN1} of the holographic picture or video are recorded, where PR_{MAX1} and P_{RMIN1} are respectively ratios of P_{MAX1} and P_{MIN1} to half of the width of a video frame of the holographic picture or video. Meanwhile, a maximum parallax percentage PR_{MAX0} and a minimum parallax percentage PR_{MIN0} that are tolerable of a watched device are set. To achieve a more desirable three-dimensional viewing effect, the maximum parallax percentage needs to be adjusted, and may be, for example, adjusted to about 80% of the maximum parallax percentage of the watched device. It should be noted that in the foregoing embodiments, a maximum parallax percentage and a minimum parallax percentage of a picture or a video are obtained only to obtain parallax of the picture or the video. In addition, because a picture or video frame have a format of a left image and a right image, to calculate a ratio, half of the width of the picture or video frame needs to be obtained. For example, the width of the picture or video frame is W, so that PR_{MAX1}=P_{MAX1}/(W/2), and PR_{MIN1}=P_{MIN1}/(W/2).

In an initialization process, parts of areas of the first image 1 and the second image 2 are obtained as the first view-finding area 11 and the second view-finding area 21. It is set that a maximum parallax percentage between the first image 1 and the second image 2 is P_{MAX1}, and the first image 1 and the second image 2 both have a width W. The first view-finding area 11 and the second view-finding area 21 both have a width w. When the parallax percentage is PR_{MAX1}, the parallax width of the first view-finding area 11 and the second view-finding area 21 is X1=PR_{MAX1}*w. When the parallax percentage is 80%*PR_{MAX0}, the parallax width of the first view-finding area 11 and the second view-finding area 21 is X₀=80%*PR_{MAX0}*w. It can be seen that to set initialization positions of the first view-finding area 11 and the second view-finding area 21 within suitable ranges, movement amounts respectively needed by the first view-finding area 11 and the second view-finding area 21 are X=(X₀−X₁)/2, where “*” denotes a multiplication sign.

During adjustment, when X>0, in such a case, parallax is relative small, and the parallax needs to be increased. Therefore, the positions of the first view-finding area and the second view-finding area both need to be translated by a distance X toward an intermediate line. As illustrated in FIG. 3, in a case in which X>0, dotted lines denote original positions of the first view-finding area and the second view-finding area, and solid lines denote positions of the first view-finding area and the second view-finding area after initialization setting.

In another case, when X<0, in such a case, parallax is relatively large, and the parallax needs to be reduced. Therefore, the first view-finding area and the second view-finding area need to be moved by a distance X in a direction away from a central line. As illustrated in FIG. 4, in a case in which X<0, dotted lines denote original positions of the first view-finding area and the second view-finding area, and solid lines denote positions of the first view-finding area and the second view-finding area after initialization setting.

Step S300: a view-finding-area adjustment step.

In the view-finding-area adjustment step, in response to a trigger instruction of the user, a position of the first view-finding area is adjusted within a range of the first image according to the trigger instruction, and at the same time a position of the second view-finding area is adjusted within a range of the second image according to the trigger instruction. A major objective of the step is to implement the change of the position of a view-finding area according to various changes of a watching status of the user or various other instructions of the user, so as to implement dynamic change and adjustment of a three-dimensional effect of an image.

The trigger instruction may include, but is not limited to, a coordinate change of the head of the user, a position change of the eyeball of the user, a speech instruction of the user, a motion instruction of the user and the like.

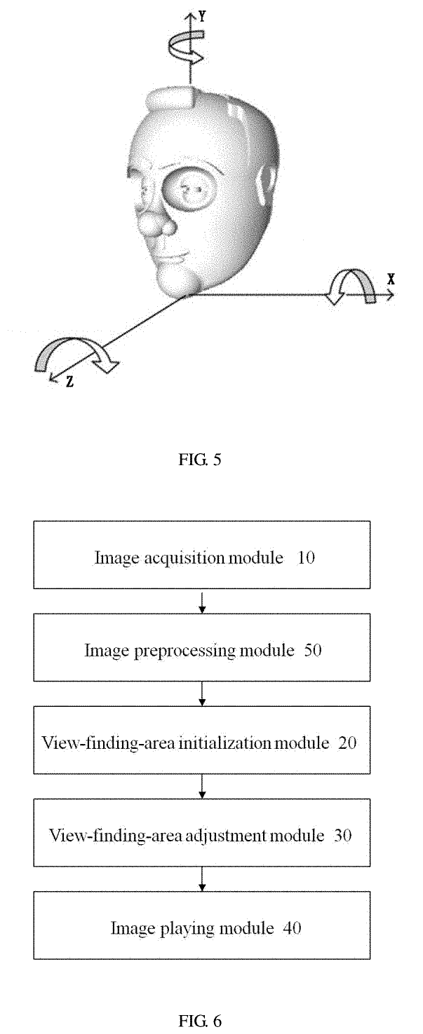

In a preferred embodiment, the trigger instruction may be coordinate change data of the head of the user. Specifically, coordinate change data of the head of the user illustrated in FIG. 5 is received, where the coordinate change data includes coordinate change amounts in three directions illustrated in FIG. 5. Specifically, pitch may be used to represent a rotational amount about the X axis (Pitch head movement), that is, a pitch angle; yaw may be used to represent a rotational amount about the Y axis (Yaw head movement), that is, a yaw angle; and roll may be used to represent a rotational amount about the Z axis (Roll head movement), that is, a roll angle. The position of the first view-finding area is adjusted within the first image range according to the coordinate change data of the head of the user, and at the same time the position of the second view-finding area is adjusted within the second image range according to the coordinate change data of the head of the user.

In a specific implementation process, the coordinate change data may be implemented by disposing a corresponding sensing apparatus. For example, change data on the left side of the head of the user may be reflected by detecting status data of a gyroscope. As illustrated in FIG. 5, coordinate values corresponding to an initial position of the head of the user may be set as reference coordinate values, and corresponding reference coordinate values recorded in the gyroscope are: picth0, yaw0, roll0. When the head of the user rotates, pitch, yaw, and roll values of real-time coordinates in the gyroscope also change correspondingly. As the pitch, yaw, and roll values change, a view-finding area also changes accordingly, so that the image seen by the user can change in real time according to the position of the head, thereby providing the user with a feeling of 360-degree watching.

The change of the yaw value is used as an example. When the yaw value in the coordinate data of the head of the user changes, it is set that an initial coordinate value is yaw0, and a changed real-time coordinate value is yaw. In this case, an amount by which the position of a view-finding area should move is YAW=yaw−yaw0. When YAW=180 degrees, the view-finding area reaches the leftmost side. When YAW=−180 degrees, the view-finding area reaches the rightmost side. When the amount by which the position of the view-finding area should move is another angle, specific position data may be calculated by using linear interpolation, and a corresponding movement is performed.

Similarly, the change of a pitch value is used as an example. It is set that an initial coordinate value is pitch0, and a changed real-time coordinate value is pitch. In this case, an amount by which the position of the view-finding area should move is PITCH=picth−picth0. When PITCH=180 degrees, the view-finding area reaches the uppermost side. When PITCH=−180, the view-finding area reaches the lowermost side. When the amount by which the position of the view-finding area should move is another angle, specific position data may be calculated by using linear interpolation, and a corresponding movement is performed.

In a specific implementation process, as illustrated in FIG. 5, the change of a Roll value reflects the movement of the entire head. During display, processing is optional. It may be understood that, this is only one of the embodiments. In a specific implementation process, the position of the view-finding area may also be adjusted according to the change of the Roll value. It should be noted that, picth0, yaw0, roll0, pitch, yaw, roll, PITCH, YAW, and the like mentioned herein may be understood as symbols of variables.

In another preferred embodiment, the trigger instruction may be a speech instruction, a motion instruction or the like from the user. A speech instruction or motion instruction from the user is received. The position of the first view-finding area is adjusted within the first image range according to the speech instruction or the motion instruction, and at the same time the position of the second view-finding area is adjusted within the second image range according to the speech instruction or motion instruction. In this embodiment, adjustment of a three-dimensional effect is implemented through adjustment of a parallax value.

Specifically, when a three-dimensional effect needs to be adjusted, a signal of a three-dimensional adjustment instruction from the user is acquired. For example, a speech instruction may be recognized by using a speech recognition technology, or a motion instruction of the user may be recognized by using a sensor. The speech instruction is used as an example. When an instruction “convex” uttered by the user is recognized, the position of the view-finding area is adjusted according to the instruction, to make a displayed scenario convex. When an instruction of “concave” uttered by the user is recognized, the position of the view-finding area is adjusted according to the instruction, to make a displayed scenario concave.

Specifically, the following process may be used for implementation. For example, when a “convex” signal is received, an image-finding area of the left image is translated to the right by M pixels, and at the same time an image-finding area of the right image moves to the left by M pixels. When N signals are received, N*M pixels are moved. When N*M is greater than X₀/2, even if a signal is received, a movement is no longer performed. Similarly, when a “concave” signal is received, the image-finding area of the left image is translated to the left by M pixels, and at the same time the image-finding area of the right image is moved to the right by M pixels. When N signals are received, N*M pixels are moved. When N*M is greater than X₀/2, even if a signal is received, a movement is no longer performed. It may be understood that the “convex” signal and the “concave” signal above are merely specific speech instructions, and may be correspondingly changed in a specific implementation process.

Step S400: an image playing step.

In the image playing step, an image corresponding to the adjusted first view-finding area is sent to a first screen for playing, and an image corresponding to the adjusted second view-finding area is sent to a second screen for playing. As discussed above, in a specific implementation process, positions of the first view-finding area and the second view-finding area are adjusted and changed in real time. Correspondingly, in the image playing step, images displayed on the first screen and the second screen are also correspondingly adjusted and changed in real time.

In a preferred embodiment, between the image acquisition step and the view-finding-area initialization step, the image playing method further includes: Step S500: an image preprocessing step.

The image preprocessing step is mainly used to adjust parameters of the first image and the second image, to reduce a color difference between the first image and the second image. For example, parameters such as color, brightness, and color saturation of the first image and the second image may be adjusted by using the image preprocessing step, to make colors of the first image and the second image as close as possible.

For the image playing method for a virtual reality device according to the present disclosure, playing of a 360-degree, three-dimensional video or picture can be performed, a relatively desirable initial parallax percentage can be automatically set, and a playing parallax percentage can also be adjusted in real time according to a related instruction, to enable a user to obtain excellent visual experience.

Correspondingly, the present disclosure further provides an image playing apparatus for a virtual reality device. The virtual reality device plays an image to the left eye of a user by using a first screen, and the virtual reality device plays an image to the right eye of the user by using a second screen. FIG. 6 illustrates a preferred embodiment of an image playing apparatus for a virtual reality device according to the present disclosure. As illustrated in FIG. 6, the image playing apparatus for a virtual reality device according to the present disclosure includes an image acquisition module 10, a view-finding-area initialization module 20, a view-finding-area adjustment module 30, and an image playing module 40, and preferably includes an image preprocessing module 50.

The image acquisition module 10 is configured to acquire a holographic image in the virtual reality device, where the holographic image includes a first image and a second image. The view-finding-area initialization module 20 is configured to set a first view-finding area on the first image, and set a second view-finding area on the second image. The view-finding-area adjustment module 30 is configured to: in response to a trigger instruction of the user, adjust a position of the first view-finding area within a range of the first image according to the trigger instruction, and at the same time adjust a position of the second view-finding area within a range of the second image according to the trigger instruction. The image playing module 40 is configured to send an image corresponding to the adjusted first view-finding area to the first screen for playing, and send an image corresponding to the adjusted second view-finding area to the second screen for playing. The image preprocessing module 50 is configured to: after the holographic image is acquired, adjust parameters of the first image and the second image, to reduce a color difference between the first image and the second image.

For the foregoing image playing apparatus for a virtual reality device, preferably, the view-finding-area initialization module further includes: a parallax-percentage-range-value calculation submodule, a parallax-percentage-range-threshold setting submodule, and a view-finding-area setting submodule.

The parallax-percentage-range-value calculation submodule is configured to calculate a parallax percentage range value between the first image and the second image. The parallax-percentage-range-threshold setting submodule is configured to set a parallax percentage range threshold, where the parallax percentage range threshold is parallax percentage range tolerable to the user when the watches an image. The view-finding-area setting submodule is configured to set the first view-finding area on the first image according to the parallax percentage range value and the parallax percentage range threshold, and at the same time set the second view-finding area on the second image according to the parallax percentage range value and the parallax percentage range threshold.

For the foregoing image playing apparatus for a virtual reality device, preferably, the view-finding-area adjustment module includes: a data receiving submodule and a first view-finding-area adjustment submodule.

The data receiving submodule is configured to receive coordinate change data of the head of the user. The first view-finding-area adjustment submodule is configured to adjust the position of the first view-finding area within the first image range according to the coordinate change data of the head of the user, and at the same time adjust the position of the second view-finding area within the second image range according to the coordinate change data of the head of the user.

For the foregoing image playing apparatus for a virtual reality device, preferably, the view-finding-area adjustment module includes: an instruction receiving submodule and a second view-finding-area adjustment submodule.

The instruction receiving submodule is configured to receive a speech instruction or motion instruction from the user. The second view-finding-area adjustment submodule is configured to adjust the position of the first view-finding area within the first image range according to the speech instruction or the motion instruction, and at the same time adjust the position of the second view-finding area within the second image range according to the speech instruction or motion instruction.

By means of the image playing method and apparatus for a virtual reality device according to the present disclosure, by means of steps such as image acquisition, view-finding-area initialization, view-finding-area adjustment, and image playing, 360-degree, three-dimensional playing of a video or a picture is implemented. Meanwhile, for the image playing method and apparatus for a virtual reality device according to the present disclosure, relatively desirable initial parallax can be further set automatically, and playing parallax can also be adjusted in real time according to a related instruction, to enable a user to obtain excellent visual experience.

The embodiment of the application provides a nonvolatile computer storage media having computer executable instructions stored thereon, wherein the computer executable instructions can perform the image playing operation processing method in any one of the foregoing embodiments of methods.

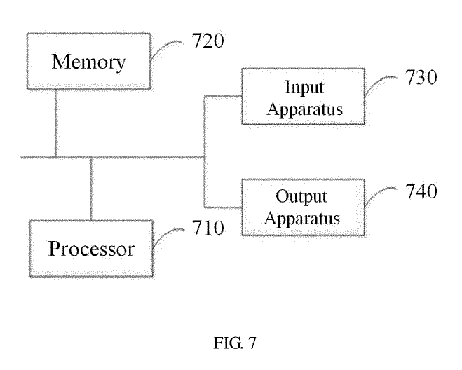

FIG. 7 is a schematic diagram of a structure of an hardware of the electronic device of the image playing method for a virtual reality device according to an embodiment of the present disclosure, as it's shown in FIG.7, the device includes:

one or more processors 710 and a memory 720, in FIG. 7, one processor 710 is employed as an example.

The electronic device of the image playing method for a virtual reality device may further includes: an input apparatus 730 and an output apparatus 740.

The processor 710, the memory 720, the input apparatus 730 and the output apparatus 740 may be connected via a bus or other means, in FIG. 7, a connection via a bus is taken as an example.

As a nonvolatile computer readable storage media, the memory 920 can be used to store nonvolatile software program, nonvolatile computer executable program and module, such as the program instructions/modules corresponding to the image playing method for a virtual reality device in the embodiments of the present disclosure (e.g., the image acquisition module 10, the view-finding-area initialization module 20, the view-finding-area adjustment module 30, and the image playing module 40 as shown in FIG. 5). The processor 710 executes various functions and applications of a server and data processing by running a nonvolatile software program, instructions and a module stored in the memory 720, so as to carry out the image playing processing method for a virtual reality device in the embodiments above.

The memory 720 may include a program storage area and a data storage area, wherein the program storage area can store an operating system, an application program required for at least one function; the data storage area can store the data created based on the use of an image playing processing device, or the like. Further, the memory 720 may include high-speed random access memory, and may further include nonvolatile memory, such as at least one disk storage device, flash memory device, or other nonvolatile solid-state memory devices. In some embodiments, the memory 720 optionally includes a memory remotely located with respect to the processor 710, which may be connected to an image playing processing device reality via a network. Examples of such network include, but not limited to, Internet, Intranet, local area network (LAN), mobile communication network, and combinations thereof.

The input apparatus 730 may receive the input numbers or characters information, as well as key signal input associated with user settings of the image playing processing device and function control. The output apparatus 740 may include a display screen or other display device.

The one or more modules are stored in the memory 720, and when being executed by the one or more processors 710, execute image playing processing method according to any one of the foregoing embodiments of methods.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present disclosure may have many forms, for example, including, but not limited to:

(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices, e.g. iPad.

(3) portable entertainment device: this type of device can display and play multimedia content. Such type of device includes: audio players (for example iPod), video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that the foregoing embodiments are merely intended for describing the technical solutions of the present disclosure rather than limiting the present disclosure. Although the present disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. An image playing method for a virtual reality device, which is applied to a virtual reality device, the virtual reality device playing an image to the left eye of a user by using a first screen, the virtual reality device playing an image to the right eye of the user by using a second screen, wherein the image playing method comprises the following steps:
an image acquisition step: acquiring a holographic image in the virtual reality device, wherein the holographic image comprises a first image and a second image;
a view-finding-area initialization step: setting a first view-finding area on the first image, and setting a second view-finding area on the second image;
a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and
an image playing step: sending an image corresponding to the adjusted first view-finding area to the first screen for playing, and sending an image corresponding to the adjusted second view-finding area to the second screen for playing.

2. The image playing method for a virtual reality device according to claim 1, wherein the view-finding-area initialization step comprises:
calculating a parallax percentage range value between the first image and the second image;
setting a parallax percentage range threshold, wherein the parallax percentage range threshold is parallax percentage range tolerable to the user when the watches an image; and
setting the first view-finding area on the first image according to the parallax percentage range value and the parallax percentage range threshold, and at the same time setting the second view-finding area on the second image according to the parallax percentage range value and the parallax percentage range threshold.

3. The image playing method for a virtual reality device according to claim 1, wherein the view-finding-area adjustment step comprises:
receiving coordinate change data of the head of the user; and
adjusting the position of the first view-finding area within the first image range according to the coordinate change data of the head of the user, and at the same time adjusting the position of the second view-finding area within the second image range according to the coordinate change data of the head of the user.

4. The image playing method for a virtual reality device according to claim 1, wherein the view-finding-area adjustment step comprises:
receiving a speech instruction or motion instruction from the user; and
adjusting the position of the first view-finding area within the first image range according to the speech instruction or the motion instruction, and at the same time adjusting the position of the second view-finding area within the second image range according to the speech instruction or motion instruction.

5. The image playing method for a virtual reality device according to claim 1, wherein between the image acquisition step and the view-finding-area initialization step, the image playing method further comprises:
an image preprocessing step: adjusting parameters of the first image and the second image, to reduce a color difference between the first image and the second image.

6. A nonvolatile computer storage media having computer executable instructions stored thereon, which is applied to a virtual reality device, wherein the virtual reality device plays an image to the left eye of a user by using a first screen, the virtual reality device plays an image to the right eye of the user by using a second screen, and the computer executable instructions are configured to:
an image acquisition step: acquiring a holographic image in the virtual reality device, wherein the holographic image comprises a first image and a second image;
a view-finding-area initialization step: setting a first view-finding area on the first image, and setting a second view-finding area on the second image;
a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and
an image playing step: sending an image corresponding to the adjusted first view-finding area to the first screen for playing, and sending an image corresponding to the adjusted second view-finding area to the second screen for playing.

7. The nonvolatile computer storage media according to claim 6, wherein the view-finding-area initialization step comprises:
calculating a parallax percentage range value between the first image and the second image;
setting a parallax percentage range threshold, wherein the parallax percentage range threshold is parallax percentage range tolerable to the user when the watches an image; and
setting the first view-finding area on the first image according to the parallax percentage range value and the parallax percentage range threshold, and at the same time setting the second view-finding area on the second image according to the parallax percentage range value and the parallax percentage range threshold.

8. The nonvolatile computer storage media according to claim 6, wherein the view-finding-area adjustment step comprises:
receiving coordinate change data of the head of the user; and
adjusting the position of the first view-finding area within the first image range according to the coordinate change data of the head of the user, and at the same time adjusting the position of the second view-finding area within the second image range according to the coordinate change data of the head of the user.

9. The nonvolatile computer storage media according to claim 6, wherein the view-finding-area adjustment step comprises:
receiving a speech instruction or motion instruction from the user; and
adjusting the position of the first view-finding area within the first image range according to the speech instruction or the motion instruction, and at the same time adjusting the position of the second view-finding area within the second image range according to the speech instruction or motion instruction.

10. The nonvolatile computer storage media according to claim 6, wherein between the image acquisition step and the view-finding-area initialization step, the image playing method further comprises:
an image preprocessing step: adjusting parameters of the first image and the second image, to reduce a color difference between the first image and the second image.

11. An image playing electronic device for a virtual reality device, which is applied to a virtual reality device, the virtual reality device playing an image to the left eye of a user by using a first screen, the virtual reality device playing an image to the right eye of the user by using a second screen, wherein the image playing electronic device comprises:
one or more processors; and
a memory;
the memory is stored with instructions executable by the one or more processors, the instructions are configured to execute: an image acquisition step: acquiring a holographic image in the virtual reality device, wherein the holographic image comprises a first image and a second image;
a view-finding-area initialization step: setting a first view-finding area on the first image, and setting a second view-finding area on the second image;
a view-finding-area adjustment step: in response to a trigger instruction of the user, adjusting a position of the first view-finding area within a range of the first image according to the trigger instruction, and at the same time adjusting a position of the second view-finding area within a range of the second image according to the trigger instruction; and
an image playing step: sending an image corresponding to the adjusted first view-finding area to the first screen for playing, and sending an image corresponding to the adjusted second view-finding area to the second screen for playing.

12. The electronic device according to claim 11, wherein the view-finding-area initialization step comprises:
calculating a parallax percentage range value between the first image and the second image;
setting a parallax percentage range threshold, wherein the parallax percentage range threshold is parallax percentage range tolerable to the user when the watches an image; and
setting the first view-finding area on the first image according to the parallax percentage range value and the parallax percentage range threshold, and at the same time setting the second view-finding area on the second image according to the parallax percentage range value and the parallax percentage range threshold.

13. The electronic device according to claim 11, wherein the view-finding-area adjustment step comprises:
receiving coordinate change data of the head of the user; and
adjusting the position of the first view-finding area within the first image range according to the coordinate change data of the head of the user, and at the same time adjusting the position of the second view-finding area within the second image range according to the coordinate change data of the head of the user.

14. The electronic device according to claim 11, wherein the view-finding-area adjustment step comprises:
receiving a speech instruction or motion instruction from the user; and
adjusting the position of the first view-finding area within the first image range according to the speech instruction or the motion instruction, and at the same time adjusting the position of the second view-finding area within the second image range according to the speech instruction or motion instruction.

15. The electronic device according to claim 11, wherein between the image acquisition step and the view-finding-area initialization step, the image playing method further comprises:
an image preprocessing step: adjusting parameters of the first image and the second image, to reduce a color difference between the first image and the second image.
